(19) United States
(12) Patent Application Publication
(10) Pub. No.: US 2012/0049994 A1
(43) Pub. Date: Mar. 1, 2012

(54) INDUCTOR CORE FOR POWER FACTOR CORRECTION CIRCUIT

(75) Inventors: Sung Yong JOO, Yongin-si (KR); Jin Hyung LEE, Anyang-si (KR)

(73) Assignee: SAMSUNG ELECTRONICS CO., LTD., Suwon-si (KR)

(21) Appl. No.: 13/027,862

(22) Filed: Feb. 15, 2011

(30) Foreign Application Priority Data
Aug. 30, 2010 (KR) 10-2010-0083884

(51) Int. Cl. H01F 27/24

(52) U.S. Cl. 336/233

(57) ABSTRACT

Disclosed herein is an inductor core usable with an interleaved Power Factor Correction (PFC) circuit. The inductor core for a power factor correction circuit, the inductor core may include: a first leg on which a first inductor is wound; a second leg on which a second inductor is wound, wherein the first and second inductors are alternately operable in an interleaved manner; and a third leg provided between the first leg and the second leg, wherein the third leg has a different shape from that of the first leg and the second leg.

### CROSS-REFERENCE TO RELATED APPLICATION

This application claims priority from Korean Patent Application No. 10-2010-0083884, filed on Aug. 30, 2010 in the Korean Intellectual Property Office, the disclosure of which is incorporated herein by reference.

### BACKGROUND

1. Field

Exemplary embodiments of the present invention relate to an inductor core usable with an interleaved power factor correction circuit.

2. Description of the Related Art

A Power Factor Correction (PFC) circuit serves as a radio-frequency device of a variety of electronic and electric appliances (for example, a display device). Such a PFC circuit has been generally employed in a power source device and serves to match a phase of input voltage with a phase of input current, so as to minimize reactive power, thus enabling efficient use of active power.

A PFC circuit has been recommended to follow European Standard IEC555-2 and IEC555-4 and American National Standard IEEE519. There are various types of PFC circuits and one example thereof is an interleaved PFC circuit. In the interleaved PFC circuit, switching elements of a control integrated circuit are controlled in a dual phase manner such that two boost inductors are alternately operated with a phase angle of 180 degrees. The dual-phase interleaved PFC circuit may more efficiently minimize reactive power than a single-phase PFC circuit and also, may reduce ripple current and Electro Magnetic Interference (EMI).

In the interleaved PFC circuit, however, each of the two boost inductors has a dual core winding configuration. Thus, each boost inductor is wound on a pair of cores and therefore, winding of the two boost inductors may require four cores. This may increase element costs and the area of a Printed Circuit Board (PCB) for arrangement of the elements. As such, there is a need for an improved core/core configuration.

### SUMMARY

An aspect of the present invention provides an inductor core for a power factor correction circuit, wherein the inductor core may include: a first leg on which a first inductor is wound; a second leg on which a second inductor is wound, wherein the first and second inductors are alternately operable in an interleaved manner; and a third leg provided between the first leg and the second leg, wherein the third leg has a different shape from that of the first leg and the second leg.

A first bobbin for winding the first inductor may be disposed on the first leg and a second bobbin for winding the second inductor may be disposed on the second leg.

The first inductor wound on the first leg and the second inductor wound on the second leg may have opposite winding directions.

A number of turns of the first inductor may be equal to a number of turns of the second inductor.

The first leg and the second leg may have a same shape.

The third leg may have a greater surface area than that of the first leg and the second leg.

The inductor core may include a first core which may be “E”-shaped and a second core, wherein the first core may include the first leg, the second leg and the third leg, and wherein the first core may be coupled to the second core.

Gaps may be between the first leg of the first core and a corresponding first leg of the second core, and the second leg of the first core and a corresponding second leg of the second core.

The second core may be “E”-shaped.

The second core may be “I”-shaped.

The inductor core may include a first core which is “E”-shaped, and a second core, wherein the first core may include the first leg, the second leg and the third leg, and wherein the first core and the second core may be coupled.

### BRIEF DESCRIPTION OF THE DRAWINGS

These and/or other aspects of the invention will become apparent and more readily appreciated from the following description of the exemplary embodiments, taken in conjunction with the accompanying drawings of which:

FIG. 1 is a diagram of an interleaved Power Factor Correction (PFC) circuit according to an exemplary embodiment of the present invention;

FIG. 2 is a perspective view illustrating a configuration of an inductor core according to an exemplary embodiment of the present invention;

FIG. 3 is a plan view according to an exemplary embodiment of the present invention;

FIG. 4 is a perspective view illustrating a coupling configuration of inductor cores according to an exemplary embodiment of the present invention;

FIG. 5 is a view illustrating a magnetic flux path according to an exemplary embodiment of the present invention;

FIG. 6 is an operating wave diagram of the interleaved PFC circuit according to the exemplary embodiment of the present invention;

FIG. 7 is a perspective view illustrating a coupling configuration of inductor cores according to another exemplary embodiment of the present invention;

FIG. 8 is a view illustrating a magnetic flux path according to an exemplary embodiment of the present invention;

FIG. 9 is a perspective view illustrating a configuration of an inductor core according to another exemplary embodiment of the present invention;

FIG. 10 is a plan view according to an exemplary embodiment of the present invention;

FIG. 11 is a perspective view illustrating a coupling configuration of inductor cores according to an exemplary embodiment of the present invention;

FIG. 12 is a view illustrating a magnetic flux path according to an exemplary embodiment of the present invention;

FIG. 13 is a perspective view illustrating a configuration of an inductor core according to a further exemplary embodiment of the present invention;

FIG. 14 is a plan view of an exemplary embodiment of the present invention;

FIG. 15 is a perspective view illustrating a coupling configuration of inductor cores according to an exemplary embodiment of the present invention; and

FIG. 16 is a view illustrating a magnetic flux path according to an exemplary embodiment of the present invention.

### DETAILED DESCRIPTION

Reference will now be made in detail to the exemplary embodiments of the present invention, examples of which are illustrated in the accompanying drawings, wherein like reference numerals refer to like elements throughout.

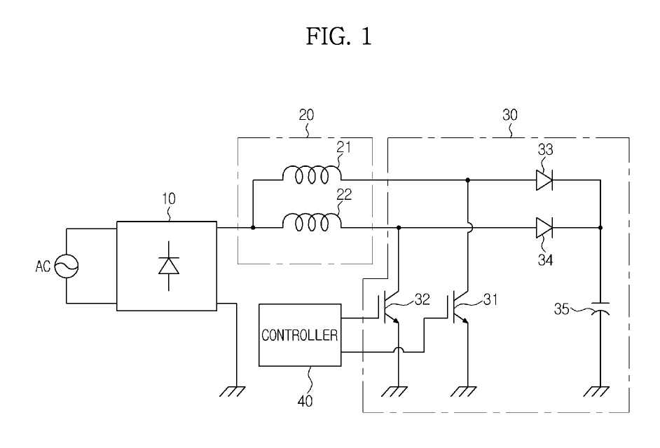

FIG. 1 is a diagram of an interleaved Power Factor Correction (PFC) circuit according to an exemplary embodiment of the present invention. The PFC circuit includes a rectifier unit 10, an inductor unit 20, a switching unit 30, and a control unit 40.

The rectifier unit 10 includes a bridge diode, and rectifies the wavelength of commercial Alternating Current (AC).

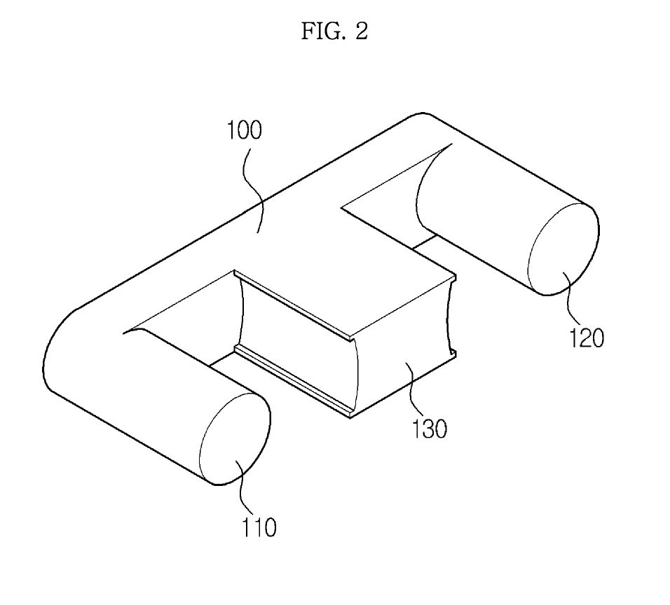

The inductor unit 20 includes a first boost inductor 21 (hereinafter, referred to as a first inductor) and a second boost inductor 22 (hereinafter, referred to as a second inductor). The first inductor 21 and the second inductor 22 are electrically connected in parallel to the rectifier unit 10. The first inductor 21 and the second inductor 22 are wound on a pair of cores. The configuration of the cores, on which the first inductor 21 and the second inductor 22 are wound, will be described later with reference to FIG. 2.

The switching unit 30 includes a first power switching element 31 and a second power switching element 32. The first power switching element 31 switches on or off power from the first inductor 21 and the second power switching element 32 switches on or off power from the second inductor 22, thus allowing the first inductor 21 and the second inductor 22 to be alternately operated with different periods, more particularly, with a phase angle of 180 degrees.

The switching unit 30 further includes a first diode 33 and a second diode 34 to rectify power upon switching of the first power switching element 31 and the second power switching element 32, and a condenser 35 to stabilize output power. The first diode 33 and the second diode 34 are connected respectively to the first power switching element 31 and the second power switching element 32 and serve to prevent reverse current from occurring when the first power switching element 31 and the second power switching element 32 are alternately switched.

The control unit 40 is an interleaved control Integrated Circuit (IC), and serves to control the operational state of the first inductor 21 and the second inductor 22 by applying induced current to allow the first inductor 21 and the second inductor 22 to be alternately operated with different periods and also, by controlling On/Off of the first power switching element 31 and the second power switching element 32 to transform input currents having different phases to be in phase.

Now, a configuration of the cores, on which the first inductor 21 and the second inductor 22 of the interleaved PFC circuit are wound, will be described with reference to FIG. 2.

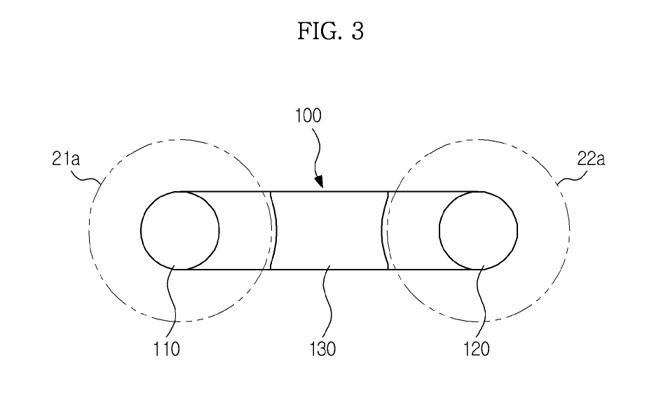

FIG. 2 is a perspective view illustrating a configuration of an inductor core according to an exemplary embodiment of the present invention, and FIG. 3 is an example of a plan view of the exemplary embodiment of FIG. 2.

In FIGS. 2 and 3, the core 100 according to the exemplary embodiment of the present invention is an “E”-shaped core having first to third legs 110, 120 and 130. The first leg 110 and the second leg 120 are provided at opposite sides of the core 100 and have the same shape and the same surface area.

The third leg 130 is located midway between the first leg 110 and the second leg 120 and has a greater surface area than that of the first leg 110 and the second leg 120 by about 2 times. The third leg 130 has a greater surface area than that of the first leg 110 and the second leg 120 so as to prevent a magnetic flux path Φ created by the first inductor 21 from overlapping with a magnetic flux path Φ created by the second inductor 22.

Opposite surfaces of the third leg 130 facing the first leg 110 and the second leg 120 are curved to enable insertion of winding bobbins 21a and 22a of the first inductor 21 and the second inductor 22. When providing the third leg 130 with the curved opposite surfaces facing the first leg 110 and the second leg 120, it may be possible to maximize the number of turns of the first inductor 21 and the second inductor 22 wound on the first leg 110 and the second leg 120, thereby realizing optimization of the core 100 based on power capacity.

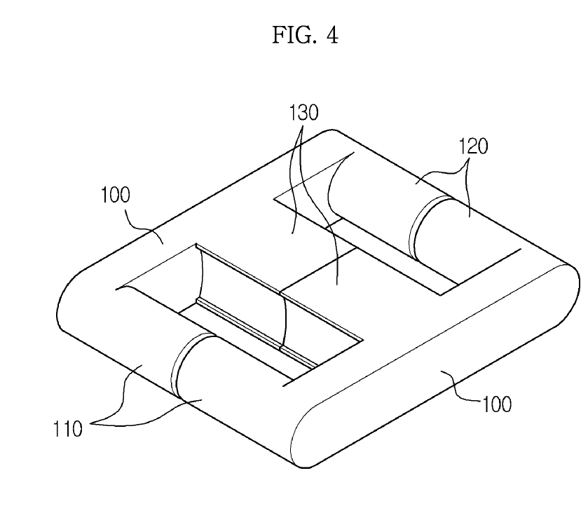

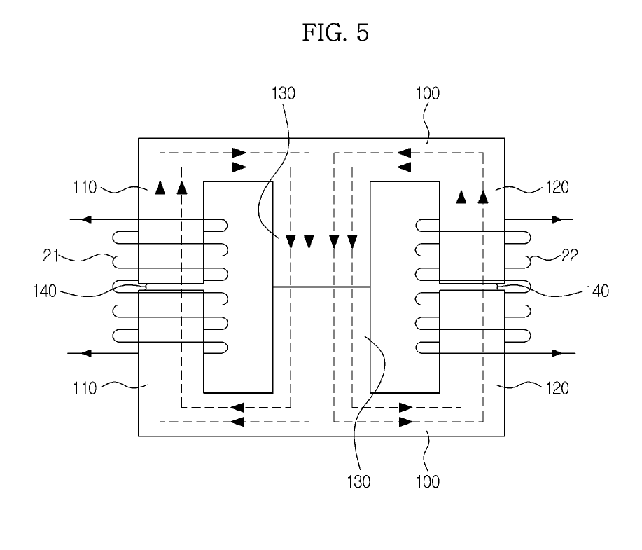

A core configuration in which the first inductor 21 and the second inductor 22 are wound on the “E”-shaped core 100 having the first to third legs 110, 120 and 130 will be described hereinafter with reference to the examples shown in FIGS. 4 and 5.

FIG. 4 is a perspective view illustrating a coupling configuration of the inductor cores according to the exemplary embodiment of the present invention, and FIG. 5 is a view illustrating an example of a magnetic flux path of the exemplary embodiment shown in FIG. 4.

In FIGS. 4 and 5, two “E”-shaped cores 100 each having the first to third legs 110, 120 and 130 are coupled to face each other to have an “EE”-shaped coupling configuration while being magnetically connected to each other. The first inductor 21 is wound on the two first legs 110 via the bobbin 21a, and the second inductor 22 is wound on the two second legs 120 via the bobbin 22a. If the first power switching element 31 and the second power switching element 32 are alternately switched according to an interleaved switching operation with a phase angle of 180 degrees, the first inductor 21 and the second inductor 22 alternately create magnetic flux paths Φ between the two third legs 130 located at the center of the cores 100 and the first legs 110 provided at one side of the cores 100 and between the two third legs 130 and the second legs 120 provided at the other side of the cores 100.

Gaps 140 to adjust inductance are defined respectively between the two first legs 110 on which the first inductor 21 is wound and between the two second legs 120 on which the second inductor 22 is wound. The gaps 140 allow the first inductor 21 and the second inductor 22 wound on the pair of “EE”-shaped cores 100 to define the two magnetic flux paths Φ.

In the PFC circuit of FIG. 1, the first power switching element 31 and the second power switching element 32 are alternately switched. Therefore, to prevent overlap of excited current upon switching of the first power switching element 31 and the second power switching element 32, the first inductor 21 wound on the two first legs 110 and the second inductor 22 wound on the two second legs 120 may have opposite winding directions. In addition, the number of turns of the first inductor 21 may be equal to the number of turns of the second inductor 22, to ensure equilibrium of excited current.

The inductor core configuration in which the two “E”-shaped cores 100 are coupled to face each other to have the “EE”-shaped coupling configuration may cut the number of cores used in the conventional configuration in half (four→two). Reducing the number of cores 100 may optimize the arrangement of elements and the size of the core 100, resulting in a reduction in overall element costs.

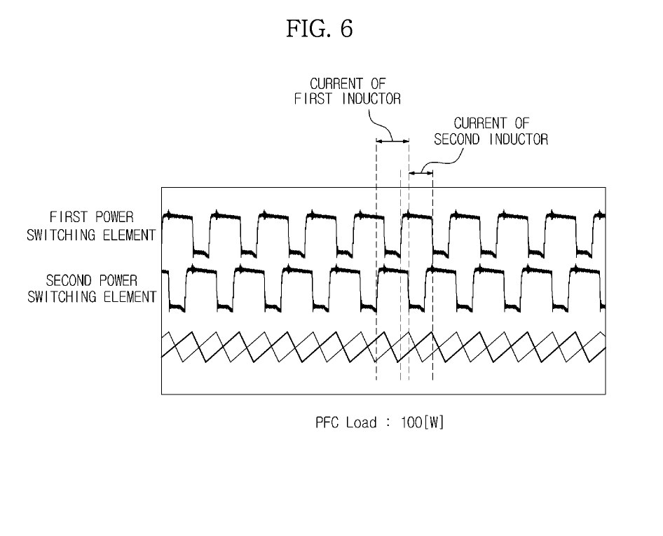

Operating waves of the interleaved PFC circuit using a single core configuration, such as the examples proposed in FIGS. 2 to 5, are illustrated in the example shown in FIG. 6.

FIG. 6 is an operating wave diagram of the interleaved PFC circuit according to the exemplary embodiment of the present invention.

As illustrated in FIG. 6, if the first power switching element 31 and the second power switching element 32 are alternately switched according to an interleaved switching operation with a phase angle of 180 degrees, the first inductor 21 wound on the two first legs 110 and the second inductor 22 wound on the two second legs 120 serve as boosters, and show the same operating waves as those measured using the conventional PFC circuit using four cores without deterioration in electric characteristics.

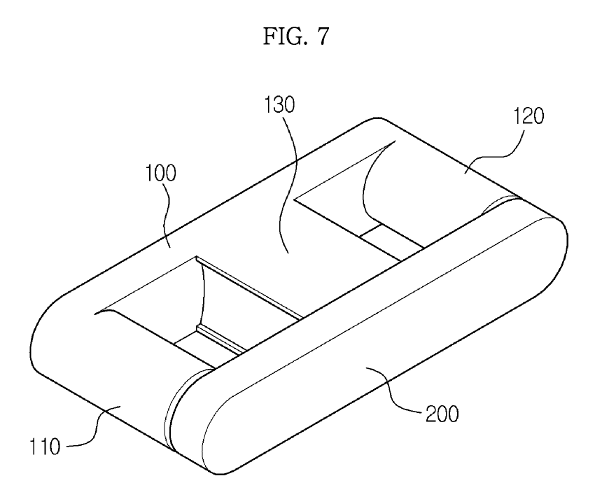

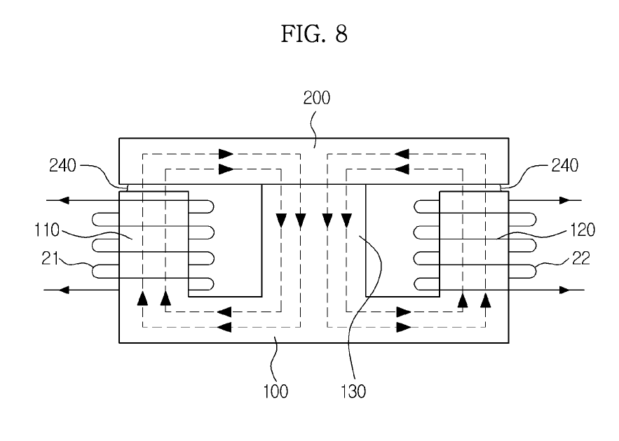

Next, in addition to the “EE”-shaped coupling configuration of the two “E”-shaped inductor cores 100 coupled to face each other which may cut the number of the cores 100 in half and optimize the size of the core 100 as compared to the conventional interleaved PFC circuit, another exemplary embodiment of the inductor core coupling configuration, which is applicable to a PFC circuit usable with a slim power source device, will be described with reference to FIGS. 7 and 8.

FIG. 7 is a perspective view illustrating a coupling configuration of inductor cores according to another exemplary embodiment of the present invention, and FIG. 8 is a view illustrating an example of a magnetic flux path of the inductor core shown in FIG. 7.

As illustrated in FIGS. 7 and 8, the “E”-shaped core 100 having the first to third legs 110, 120 and 130 illustrated in FIGS. 2 and 3 is coupled to a bar-type “I”-shaped core 200 having no legs to have an “EI”-shaped coupling configuration while being magnetically connected to each other. In the “EI”-shaped coupling configuration of the cores 100 and 200, the first inductor 21 is wound on the first leg 110 of the core 100 via the bobbin 21a, and the second inductor 22 is wound on the second leg 120 of the core 100 via the bobbin 22a. The first inductor 21 and the second inductor 22 respectively create magnetic flux paths Φ between the third leg 130 and the first leg 110 and between the third leg 130 and the second leg 120.

Gaps 240 to adjust inductance are defined respectively between the first leg 110 of the core 100 on which the first inductor 21 is wound and one end portion of the core 200 and between the second leg 120 on which the second inductor 22 is wound and the other end portion of the core 200. The gaps 240 allow the first inductor 21 and the second inductor 22 wound on the pair of “EI”-shaped cores 100 to define the two magnetic flux paths Φ.

In the “EI”-shaped coupling configuration, similar to the “EE”-shaped coupling configuration, to prevent overlap of excited current upon switching of the first power switching element 31 and the second power switching element 32, the first inductor 21 wound on the first leg 110 and the second inductor 22 wound on the second leg 120 may have opposite winding directions. In addition, the number of turns of the first inductor 21 may be equal to the number of turns of the second inductor 22, to ensure equilibrium of excited current.

As will be appreciated from FIG. 8, in the inductor cores 100 and 200 having the “EI-”shaped coupling configuration, the number of turns of the first inductor 21 and the second inductor 22 wound on the first leg 110 and the second leg 120 of the core 100 is less than those of the inductor cores 100 having the “EE”-shaped configuration. Thus, the inductor cores having the “EI”-shaped coupling configuration has a smaller overall size than the inductor cores having the “EE”-shaped coupling configuration illustrated in FIG. 5 and thus, may realize a PFC circuit usable with a slim power source device.

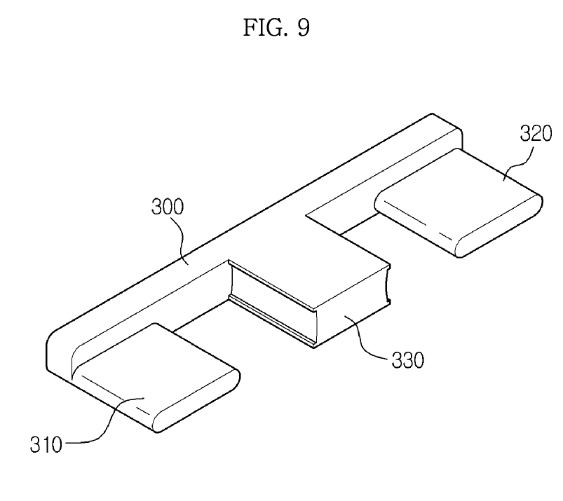

Next, various inductor configurations applicable to the interleaved PFC circuit will be described with reference to the exemplary embodiments shown in FIGS. 9 to 16.

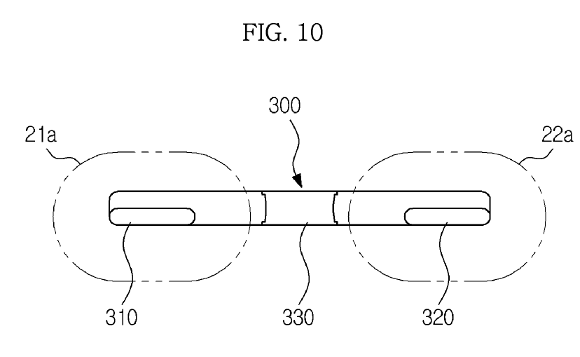

FIG. 9 is a perspective view illustrating a configuration of an inductor core according to another exemplary embodiment of the present invention, and FIG. 10 is an example plan view of the exemplary embodiment of FIG. 9.

Although the core 300 illustrated in FIGS. 9 and 10 is an “E”-shaped core having first to third legs 310, 320 and 330 similar to the core 100 illustrated in FIGS. 2 and 3, the core 300 has a modified configuration of the basic configuration of the core 100 illustrated in FIGS. 2 and 3 such that the first leg 310 and the second leg 320 of the core 300 have an elliptical cross section rather than a circular cross section. Of course, the “E”-shaped modified core 300 illustrated in FIGS. 9 and 10 may also be modified to have other various shapes in consideration of the arrangement of elements, the overall size, or the power capacity of the PFC circuit.

The first leg 310 and the second leg 320 of the “E”-shaped modified core 300 are provided at opposite sides of the “E”-shaped modified core 300 and have the same shape and the same surface area.

The third leg 330 of the “E”-shaped modified core 300 is located midway between the first leg 310 and the second leg 320 and has a modified shape different from the first leg 310 and the second leg 320 to have a greater surface area and height than those of the first leg 310 and the second leg 320 by about 2 times.

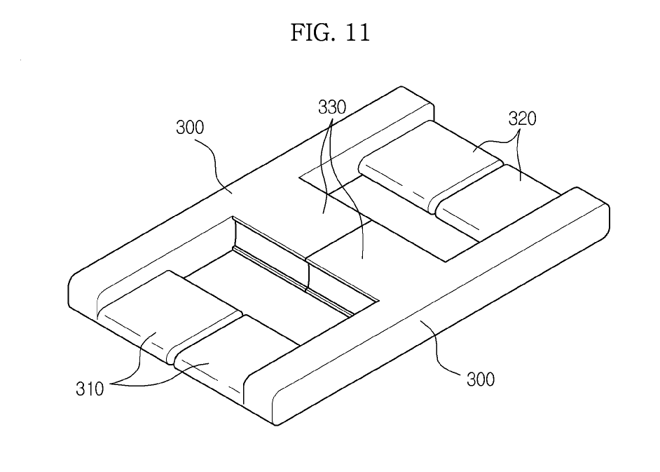

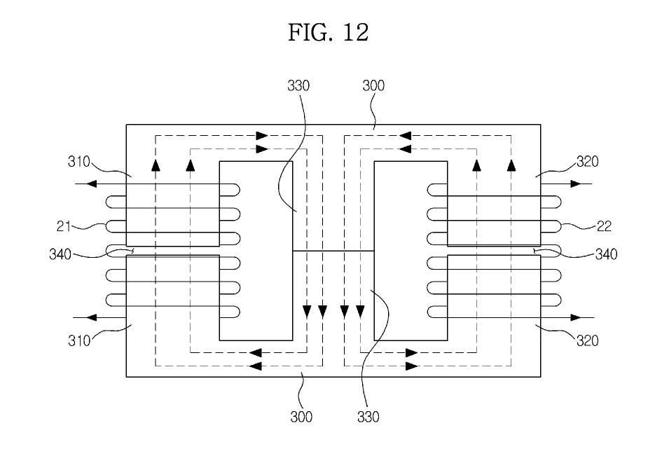

FIG. 11 is a perspective view illustrating a coupling configuration of the inductor cores of FIG. 9, and FIG. 12 is a view illustrating an example of a magnetic flux path of the exemplary embodiment of FIG. 11.

In FIGS. 11 and 12, two “E”-shaped modified cores 300 each having the first to third legs 310, 320 and 330 are coupled to face each other to have an “EE”-shaped coupling configuration while being magnetically connected to each other. The first inductor 21 is wound on the two first legs 310 via the bobbin 21a, and the second inductor 22 is wound on the two second legs 320 via the bobbin 22a. The first inductor 21 and the second inductor 22 create magnetic flux paths Φ between the two third legs 330 and the first legs 310 and between the two third legs 330 and the second legs 320.

Gaps 340 to adjust inductance are defined respectively between the two first legs 310 on which the first inductor 21 is wound and between the two second legs 320 on which the second inductor 22 is wound. The gaps 340 allow the first inductor 21 and the second inductor 22 wound on the pair of “EE”-shaped cores 300 to define the two magnetic flux paths Φ.

As described above, in the PFC circuit of FIG. 1, the first power switching element 31 and the second power switching element 32 are alternately switched. Therefore, to prevent overlap of excited current upon switching of the first power switching element 31 and the second power switching element 32, the first inductor 21 wound on the two first legs 310 and the second inductor 22 wound on the two second legs 320 of the “E”-shaped modified core 300 may have opposite winding directions. In addition, the number of turns of the first inductor 21 may be equal to the number of turns of the second inductor 22, to ensure equilibrium of excited current.

The inductor core configuration in which the two “E”-shaped cores 300 are coupled to face each other to have the “EE”-shaped coupling configuration may cut the number of cores used in the conventional configuration in half (four→two), and also, may realize various sizes of the core 300, expanding the utilization range of the core 300.

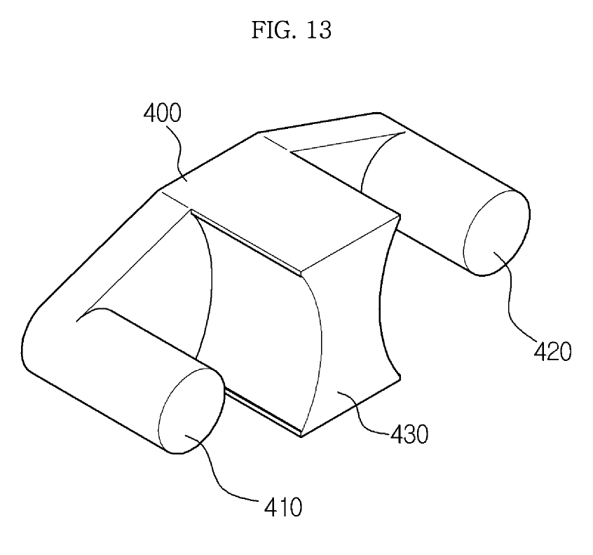

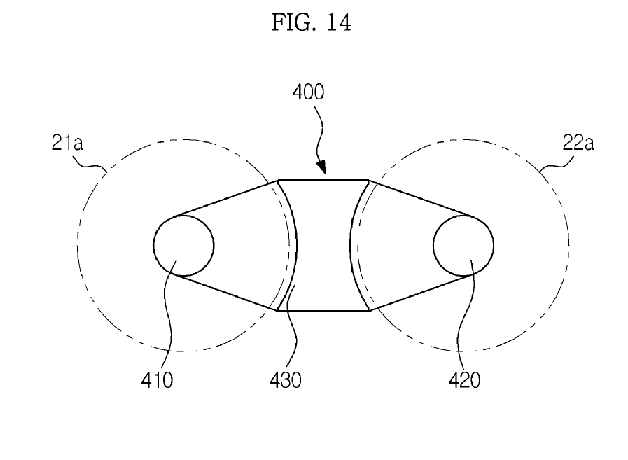

FIG. 13 is a perspective view illustrating a configuration of an inductor core according to a further exemplary embodiment of the present invention, and FIG. 14 is an example of a plan view of the exemplary embodiment of FIG. 13.

Although the core 400 illustrated in FIGS. 13 and 14 is an “E”-shaped core having first to third legs 410, 420 and 430 similar to the core 100 illustrated in FIGS. 2 and 3, the core 400 has a modified configuration of the basic core 100 illustrated in FIGS. 2 and 3 such that the third leg 430 has a modified height. Of course, the “E”-shaped modified core 400 illustrated in FIGS. 13 and 14 may also be modified to have other various shapes in consideration of the arrangement of elements, the overall size, or the power capacity of the PFC circuit using the inductor core 400.

The first leg 410 and the second leg 420 of the “E”-shaped modified core 400 are provided at opposite sides of the “E”-shaped modified core 400 and have the same shape and the same surface area.

The third leg 430 of the “E”-shaped modified core 400 is located midway between the first leg 410 and the second leg 420 and has a modified shape different from the first leg 410 and the second leg 420 to have a greater height than those of the first leg 410 and the second leg 420 by about 2 times.

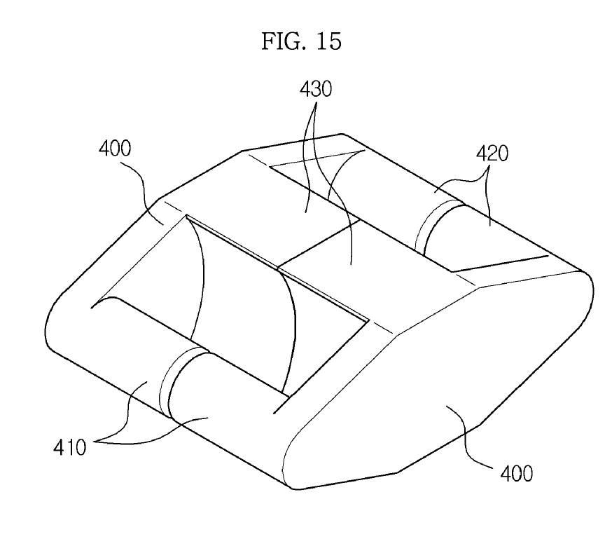

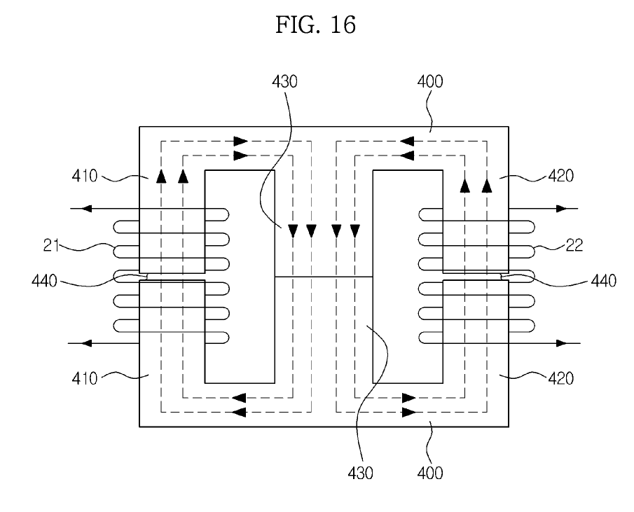

FIG. 15 is a perspective view illustrating an example of a coupling configuration of the exemplary embodiment of FIG. 13, and FIG. 16 is a view illustrating an example of a magnetic flux path of the exemplary embodiment of FIG. 15.

In FIGS. 15 and 16, two “E”-shaped modified cores 400 each having the first to third legs 410, 420 and 430 are coupled to face each other to have an “EE”-shaped coupling configuration while being magnetically connected to each other. The first inductor 21 is wound on the two first legs 410 via the bobbin 21a, and the second inductor 22 is wound on the two second legs 420 via the bobbin 22a. The first inductor 21 and the second inductor 22 create magnetic flux paths Φ between the two third legs 430 and the first legs 410 and between the two third legs 430 and the second legs 420.

Gaps 440 to adjust inductance are defined respectively between the two first legs 410 on which the first inductor 21 is wound and between the two second legs 420 on which the second inductor 22 is wound. The gaps 440 allow the first inductor 21 and the second inductor 22 wound on the pair of “EE”-shaped cores 400 to define the two magnetic flux paths Φ.

As described above, in the PFC circuit of FIG. 1, the first power switching element 31 and the second power switching element 32 are alternately switched. Therefore, to prevent overlap of excited current upon switching of the first power switching element 31 and the second power switching element 32, the first inductor 21 wound on the two first legs 410 and the second inductor 22 wound on the two second legs 420 of the “E”-shaped modified core 400 may have opposite winding directions. In addition, the number of turns of the first inductor 21 may be equal to the number of turns of the second inductor 22, to ensure equilibrium of excited current.

The inductor core configuration in which the two “E”-shaped cores 400 are coupled to face each other to have the “EE”-shaped coupling configuration may cut the number of cores used in the conventional configuration in half (four→two), and also, may realize various sizes of the core 400, expanding the utilization range of the core 400.

In the case of the inductor cores having the coupling configurations illustrated in FIGS. 4, 7, 11 and 15, all the inductor cores may be mounted on a Printed Circuit Board (PCB) in a standing manner or in a laying manner.

As is apparent from the above description, an interleaved PFC circuit according to the exemplary embodiments of the present invention has an improved core configuration in which two boost inverters are wound on a pair of cores, thereby cutting the number of cores used in the conventional core configuration in half, resulting in optimized element arrangement and core size and consequently, reduced costs. In the case of a small-capacity PFC circuit, a bar-type core may be used to realize a boost inductor configuration using a single-core.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An inductor core for a power factor correction circuit, the inductor core comprising:
a first leg on which a first inductor is wound;
a second leg on which a second inductor is wound, wherein the first and second inductors are alternately operable in an interleaved manner; and
a third leg provided between the first leg and the second leg,
wherein the third leg has a different shape from that of the first leg and the second leg.

2. The inductor core according to claim 1, wherein a first bobbin for winding the first inductor is disposed on the first leg and a second bobbin for winding the second inductor is disposed on the second leg.

3. The inductor core according to claim 1, wherein the first inductor wound on the first leg and the second inductor wound on the second leg have opposite winding directions.

4. The inductor core according to claim 1, wherein a number of turns of the first inductor is equal to a number of turns of the second inductor.

5. The inductor core according to claim 1, wherein the first leg and the second leg have a same shape.

6. The inductor core according to claim 1, wherein the third leg has a greater surface area than that of the first leg and the second leg.

7. The inductor core according to claim 1, wherein:
the inductor core includes a first core which is “E”-shaped and a second core,
wherein the first core includes the first leg, the second leg and the third leg, and
wherein the first core is coupled to the second core.

8. The inductor core according to claim 7, wherein a first gap is between the first leg of the first core and a corresponding first leg of the second core and a second gap is between the second leg of the first core and a corresponding second leg of the second core.

9. The inductor core according to claim 7, wherein the second core is “E”-shaped.

10. The inductor core according to claim 7, wherein the second core is “I”-shaped.

11. The inductor core according to claim 6, wherein:
the inductor core includes a first core which is “E”-shaped, and a second core,
wherein the first core includes the first leg, the second leg and the third leg, and
wherein the first core and the second core are coupled.

12. The inductor core according to claim 11, wherein a first gap is between the first leg of the first core and a corresponding first leg of the second core and a second gap is between the second leg of the first core and a corresponding second leg of the second core.

13. The inductor core according to claim 11, wherein the first leg and the second leg have a same shape.

14. The inductor core according to claim 11, wherein the second core is “E”-shaped.

15. The inductor core according to claim 11, wherein the second core is “I”-shaped.
